(19) United States
(12) Patent Application Publication
(10) Pub. No.: US 2002/0081017 A1
(43) Pub. Date: Jun. 27, 2002

(54) Image registration using binned substrate parameters

(76) Inventors: Steven S. Smith, Tucson, AZ (US); James R. Strickland, Tucson, AZ (US); Hyup Cho, Tucson, AZ (US); John Engel, Tucson, AZ (US)

Correspondence Address: APPLIED MATERIALS, INC., Patent Department, P.O. Box 450A, Santa Clara, CA, 95052, US

(21) Appl. No.: 09/747,381

(22) Filed: Dec. 23, 2000

(51) Int. Cl. G06K 9/00

(52) U.S. Cl. 382/151

(57) ABSTRACT

In the registration of images on a substrate, a substrate parameter is determined for the substrate. A bin data set defining a plurality of bins that each delimit a range of substrate parameters and have an associated bin instruction is retrieved. The particular bin that contains the determined substrate parameter and its associated bin instruction is identified. In response to this bin instruction, the determination of the substrate parameter is repeated, the substrate is rejected, or an image is scaled and registered on the substrate.

### BACKGROUND

Embodiments of the present invention relate to the registration of an image on a substrate, such as a multilayer printed circuit board.

Multilayer printed circuit boards (PCBs) are typically made from a number of separate boards which are imaged in separate laser direct imaging (LDI) steps and adhered together. Typically, each board comprises a dielectric base, an overlying conductor layer, and an upper photoresist layer. In the image registration process, the dimensional changes or distortions that occur in a board are determined from the measured deviations of one or more fiducial marks of the board. An image scaling factor is calculated from the measured fiducial mark deviations and the circuit image for the board is scaled by the image scaling factor. Thereafter, a modulated radiation beam registers the scaled circuit image on the photoresist layer of the board. The board is then developed to form a photoresist pattern and the underlying conductor layer is etched to form a scaled circuit pattern on the board. After a number of such boards having scaled circuit patterns are made, they are assembled and adhered to form a multi-layer PCB.

However, conventional methods for scaling each circuit image according to the distortions of the board often result in alignment problems when the scaled circuit patterns on different boards are assembled together. Conventional image scaling methods calculate and use an image scaling factor from a continuously variable scaling range containing an infinite number of possible image scaling factors. The continuous-range scaling can result in a slightly different image scaling factor for each board and this can result in a unique scaled circuit image pattern on each board. When these differently scaled circuit patterns are assembled to be electrically connected to each other by vias and conducting pads, the circuit patterns are often improperly connected with discontinuities or misaligned contacts occurring in the fully assembled multilayer PCB. This lowers the yields of the multilayer PCBs and increases manufacturing costs.

Conventional circuit image scaling may also cause problems in the alignment of the scaled circuit patterns on the same board. Often each board is fabricated with different circuit patterns on the top and bottom side of the board. The two circuit patterns may be scaled with different image scaling factors, for example, when the fiducial mark deviations on each side of the board are measured slightly differently because they are measured in two separate and independent steps. The resulting slightly different image scaling factors used on each side of the board causes the two circuit images to be scaled differently and they may not match in size or shape. Thus, independent continuous-range scaling of the two circuit images on the two sides of a board sometimes results in electrical faults such as conducting discontinuities in the manufactured PCB.

Accordingly, it is often desirable to be able to scale a circuit image to reduce electrical faults and discontinuities between two circuits on the same board or between the circuits of different boards in an assembled multilayer PCB. It is further desirable to scale the circuit images by an efficient and high throughput scaling system.

### SUMMARY

Embodiments of the present invention are capable of satisfying one or more of these needs. In one aspect, the present invention comprises an image registration apparatus comprising components adapted to generate, modulate and scan one or more radiation beams across the substrate, the components including a substrate support capable of supporting a substrate, and a controller adapted to (i) determine a substrate parameter, (ii) retrieve a bin data set defining a plurality of bins that each delimit a range of the substrate parameters and have an associated bin instruction, (iii) identify the bin containing the determined substrate parameter and the associated bin instruction, and (iv) repeat the determination of the substrate parameter, reject the substrate, or scale an image and communicate with the components to register the image on the substrate.

In another aspect, the invention comprises an image registration method comprising placing a substrate on a substrate support, determining a substrate parameter for the substrate, obtaining a bin data set defining a plurality of bins that each delimit a range of substrate parameters and have an associated bin instruction, identifying the bin containing the determined substrate parameter and the associated bin instruction, and in response to the bin instruction, repeating the determination of the substrate parameter, rejecting the substrate, or scaling and registering an image on the substrate.

### DRAWINGS

These features, aspects, and advantages of the present invention will become better understood with regard to the following description, appended claims, a and accompanying drawings which illustrate examples of the invention. However, it is to be understood that each of the features can be used in the invention in general, not merely in the context of the particular drawings, and the invention includes any combination of these features, where:

FIG. 1 is a schematic diagram of an image registration apparatus according to the present invention;

FIG. 2 is a schematic diagram of a controller and computer program;

FIG. 3 is a schematic diagram of a bin data set comprising ranges of substrate parameters according to the present invention;

FIG. 4 is a schematic diagram of alternatively defined bin data set comprising ranges of substrate parameters according to the present invention;

FIG. 5 is a schematic diagram of a bin set interface according to the present invention;

FIG. 6 is a schematic diagram of an image job data file according to the present invention; and

FIG. 7 is a schematic diagram of a bin set data file according to the present invention.

### DESCRIPTION

An image registration apparatus 100 according to an embodiment of the present invention is useful for registering an image on a substrate 110. Typically, the substrate 110 comprises dielectric, semiconductor or conductor materials. A suitable substrate 110 may be, for example, a circuit board upon which an image is registered and which is adhered to other such boards to form a multilayer printed circuit board (PCB). A typical circuit board comprises dielectric and conducting layers, for example, a dielectric layer comprising a composite of a thermosetting epoxy resin infiltrated in a reinforcing glass cloth, and conducting layer comprising a metal layer, such as a copper layer. A photoresist material covers the board to receive and register a circuit image. However, the substrate may also be a mask that is used in the fabrication of semiconductor circuits.

Typically, the substrate 110 comprises fiducial marks 177 which serve as reference points to make measurements on the substrate 110, for example, by comparing an original or intended location of a fiducial mark 177 to a moved location that occurs after partial processing of the substrate 110. The fiducial marks 177 may have a shape suitable to be detected, such as a dot or rectangle, and may be an inhomogeneity in the substrate 110, such as a different material, protrusion, or cavity. For circuit board type substrates 110, the fiducial marks 177 typically comprise a material different from the surrounding substrate material, such as a conducting or reflecting material, a physical protrusion, or a void. For mask type substrates the fiducial marks 177 may comprise a conductor, such as a metal, for example, aluminum. The fiducial marks 177 are placed in or on the substrate 110 according to intended locations and are subsequently located to determine their moved locations. The fiducial mark deviations between the intended locations and measured locations yield information about properties of the substrate 110 that are useful in the image registration process.

Generally, the image registration apparatus 100 comprises a number of components 101 to generate, modulate and scan one or more radiation beams 135 across the substrate 110 to register an image on the substrate 110. The components 101 include a substrate support 105 capable of supporting the substrate 110, support motors 115 capable of moving the support 105 to precisely position the substrate 110, and support position sensors 120 capable of precisely determining the position of the substrate 110 or the support 105. The support motors 115 may comprise motors that translate the support 105 in the plane parallel to the substrate surface, rotate the support 105, or tilt the support 105. The support position sensors 120 may operate by reflecting a light beam (not shown) from the support 105 and measuring the back-and-forth travel time. A vacuum pump 125 and vacuum port 128 are also provided to securely hold the substrate 110 by vacuum force.

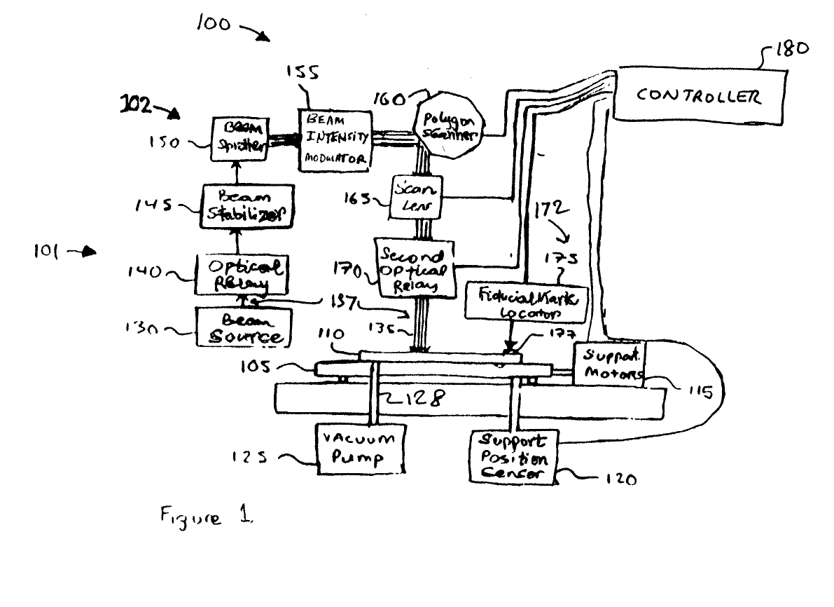

The apparatus components 101 further comprise a radiation beam source 130 capable of generating a radiation beam 135 that travels along a beam path 137 to register an image on the substrate 110. The radiation beam source 130 generates a radiation beam 135 comprising radiation in the ultraviolet, visible, x-ray, microwave or infrared portions of the electromagnetic frequency spectrum, or radiation comprising a charged particle beam such as an electron beam. In the embodiment of the apparatus illustrated herein, a suitable radiation beam source 130 comprises a laser beam source that generates an ultraviolet continuous-wave laser beam having primary spectral lines at wavelengths 351 nm, 364 nm and 380 nm. The apparatus represents a DigiRite 2000 (™) laser beam image registration apparatus commercially available from Etec Systems, Inc., Tucson, Ariz., a division of Applied Materials, and which is schematically illustrated in FIG. 1. However, the illustrative embodiment of the apparatus 110 provided herein should not be used to limit the scope of the invention, and the invention encompasses alternative versions of the apparatus that may operate according to the principles of the present invention, as would be apparent to one of ordinary skill in the art. For example, the apparatus 100 may be an electron beam imaging apparatus, comprising an electron beam source with suitably modified electron beam focusing, scanning and modulating components, as apparent to one of ordinary skill in the art and as for example disclosed in U.S. Pat. No. 5,876,902, which is incorporated herein by reference in its entirety.

The apparatus components 101 further comprise beam modulating components 102 that modulate the radiation beam 135. For example, the beam modulating components 102 may include a first optical relay 140, beam stabilizer 145, beam splitter 150, and beam intensity modulator 155, in the radiation beam path 137. The first optical relay 140 is used to transport the radiation beam 135 from the radiation beam source 130 to the beam stabilizer 145. The optical relay 140 typically comprises optical elements, such as lenses, capable of passively shaping the radiation beam 135 to a shape suitable to be used by the other apparatus components 101. The beam stabilizer 145 stabilizes the position of the beam 135 and passes it to the beam splitter 150. The beam stabilizer 145 comprises optical elements, such as lenses or mirrors, capable of adjusting and maintaining a stabilized position of the beam 135. The beam splitter 150 splits the stabilized laser beam 135 into a plurality of laser beamlets (for example, two, four, or eight), and passes them to a beam intensity modulator 155. The beam intensity modulator 155 comprises, for example, an acousto-optic modulator that uses constructive and destructive interference of the radiation beamlets to modulate the intensity of the beamlets according to an electrical signal corresponding to the image.

The apparatus components 101 also comprise scanning components to scan the radiation beam 135 across the substrate 110. A suitable scanner 160 for a laser radiation beam may be, for example, a rotating polygon mirror, capable of raster scanning the modulated radiation beam 135 along a scan direction across the substrate 110, while the support motors 115 move the support 105 in a cross-scan direction substantially perpendicular to the scan direction. The scanner 160 rotates to change the angles of incidence and reflection of the radiation beam 135 to scan the beam 135 along a scanning stripe. A scan lens 165 focuses the modulated and scanned beam 135 to, for example, reduce the separation between beamlets, by providing an anamorphic magnification between the scan direction and the cross-scan direction. A second optical relay 170 reforms the image formed by the scan lens 165 and may be used to reduce optical constraints on the scan lens 165.

A controller 180, comprising a suitable configuration of hardware and software, processes a circuit image and operates the components 101 to register the patterned image on the substrate 110. An exemplary controller 180 comprises a central processing unit (CPU) 182 comprising a microprocessor 187, such as a complex instruction set computer (CISC) microprocessor, for example a Pentium (™) microprocessor commercially available from Intel Corporation, Santa Clara, Calif., or a reduced instruction set computer (RISC) microprocessor, capable of executing a computer program 195, and that is connected to a memory 181 and other components. The memory 181 may comprise a computer-readable medium such as hard disks in a redundant array of independent disks (RAID) 186, removable storage 183 such as a compact disc (CD) or floppy disk, random access memory (RAM) 184, and/or other types of volatile or non-volatile memory. The interface between a human operator and the controller 180 can be, for example, via a display 188, such as a cathode ray tube (CRT) monitor, and an input device, such as a keyboard 190. The controller 180 may also include interface boards 191, such as analog and digital input/output boards, linear motor driver boards, or stepper motor controller boards.

The controller 180 is adapted to generate, send, and receive signals to communicate with and control the components 101 to register the image on the substrate 110, including for example communicating with the radiation beam source 130, the beam modulating components 102, support motors 115, support position sensors 120, and a substrate attribute detector 172 to measure an attribute of the substrate 110, such as a fiducial mark locator 175 to locate the fiducial marks 177 on the substrate 110. For example, the controller 180 may send real-time instruction signals to the support motors 115 to control the motion of the substrate 110 to scale, rotate, or offset the image registered on the substrate 110. The controller 180 may also send a real-time data signal to the beam modulating components 102 to modulate the radiation beam 135 to the desired intensity levels and in correspondence to a predetermined image data file 85. The controller 180 may also be used to scale the image by calculating a scaled image data file in response to a determined image scaling factor or by electronically controlling the beam position and substrate movement during registration.

The computer program 195 can be generated in any conventional programming language that is readable by the controller 180, such as for example, assembly language, C, C++ or Pascal. Suitable programming language code is entered into a single file, or multiple files, using a conventional text editor and stored or embodied in the memory 181 of the controller 180. If the entered programming language code is in a high level language, the programming language code is compiled to generate executable code, and the resultant executable code is linked with an object code of pre-compiled library routines. To execute the linked, compiled object code, the operator invokes the feature code, causing the CPU 182 to read and execute the code to perform the tasks identified in the computer program 195. Using a keyboard interface, a human operator enters commands or registration parameters into the computer program 195 in response to menus or screens displayed on the display 188. The computer program 195 may include instruction sets to, for example, control the support positioning, fiducial mark location, beam modulation, or A compression of the data signal. The instruction sets may receive parameters, such as the image data file 85 corresponding to the image, the fiducial mark locations, the support position, and parameter entered by the human operator. The computer program 195 may also comprise instruction sets to store information relating to the substrate or image registration in the memory 181, such as the fiducial mark deviations, image scaling factors, or information identifying an image registration step such as lot or batch identification.

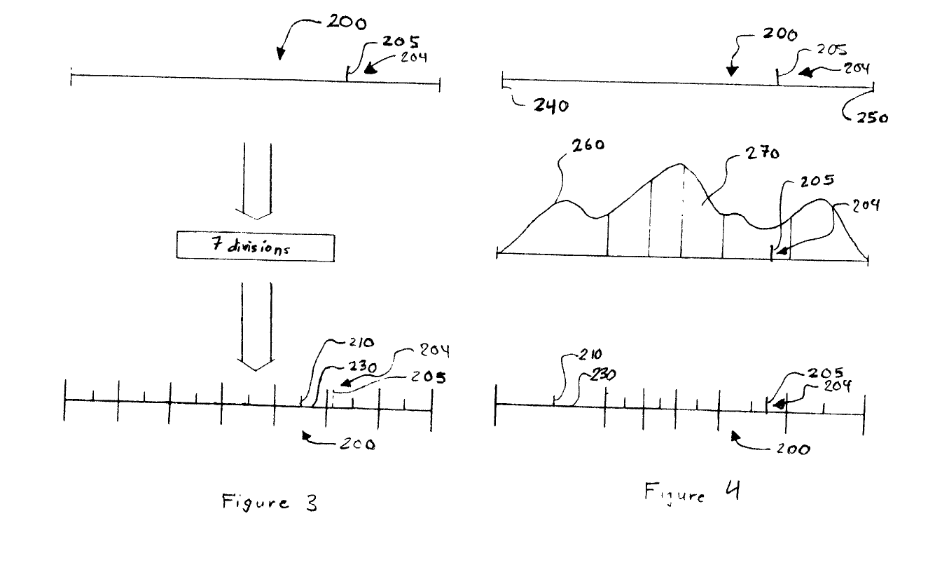

In one aspect of the present invention, the controller 180 is adapted to determine a substrate parameter. The substrate parameter may be a parameter associated with the substrate 110, such as a dimension of the substrate 110, an image scaling factor to scale the image to be registered on the substrate 110, or a distortion level of the substrate 110; or may be a parameter associated with a batch of substrates such as a common distortion measurement of the substrates 110. The controller 180 may determine the substrate parameter by retrieving the parameter from a memory 181, measuring the parameter, or calculating the parameter from a substrate measurement. In one version, a substrate distortion level as represented by a fiducial mark deviation of the fiducial marks 177 on the substrate 110 is determined and received by the controller 180. The controller 180 uses the fiducial mark to determine a substrate parameter such as an image scaling factor 205, as for example illustrated in FIG. 3, to scale the circuit image to be registered on the substrate 110. The image scaling factor 205 may be used to correct the circuit image 85 for a scaling, rotational, translational, or skewed distortion of the substrate 110. The image scaling factor 205 may be determined from a mathematical expression that operates on the measured fiducial mark deviations. For example, the image scaling factor 205 may be a linear or a nonlinear function of the measured fiducial mark deviations. Alternatively, the image scaling factor 205 may be determined from a lookup table that relates a set of measured fiducial mark deviations to a set of predefined image scaling factors. The lookup table may be, for example, stored in the memory 181 of the controller 180.

The controller 180 is further adapted to obtain a bin data set 212 comprising a plurality of bins 214 that each delimit a range 230 of the substrate parameters and have an associated bin instruction 216, as schematically illustrated in FIG. 7. The bin data set 212 comprises data that is readable by the controller 180 and may be, for example, in the form of computer program code data. A bin set data file 492 that contains the bin data set 212 resides in the memory 181 of the controller 180 and may be created, retrieved, or modified by a human operator to define the bin data set 212, or may be determined or calculated by the controller 180. The bin data set 212 comprises bins 214 that each define a range 230 of substrate parameters. The bins 214 are simply designations for predefined ranges 230 of the substrate parameters. The ranges 230 may be arbitrarily defined or delimited according to predefined criteria and each range 230 may correspond to a continuous or discontinuous set of substrate parameters. For example, a human operator may enter a desired total range 200 and the controller 180 may divide the total range 200 into a number of ranges 230; and thereafter set the bin designations for each range 230 of substrate parameters. The predefined bin data set 212 is stored in the memory 181 of the controller 180.

The bin data set 212 may also be set from experimentally determined data. For example, an operator may determine the total range 200 of the substrate parameters that are encompassed by all the bins 214, for example, from a minimum value and a maximum value of the substrate parameters, such as measured fiducial mark deviations, for a batch of substrates. The derived total range 200 of substrate parameters may be modified, for example, by excluding the substrate parameters that are at the limits of the derived total range 200. The resultant experimentally derived total range 200 may be divided into a plurality of smaller ranges 230 which may each be identified by a bin number. For example, as illustrated in FIG. 3, the ranges 230 of substrate parameters of each bin 214 may be approximately equally sized. In this version, the size of each range 230 may be equal to the difference between the minimum and maximum value of the total range 200, divided by the desired number of ranges 230 (or bins 214) so that the total range 200 is divided into a plurality of equally sized ranges 230 for each bin 214.

The bin data set 212 may also be generated by the controller 180. In this version, the controller 180 operates the components 101 to measure substrate parameters for a plurality of test substrates, evaluates a probability distribution of the measured substrate parameters, and defines the bin data set 212 according to the probability distribution 260. For example, substrate parameters of the set of sample substrates may be measured. From the probability distribution of the occurrences of the measured substrate parameters, a probability distribution curve 260 is determined. The area 270 between the part of the horizontal axis in a range 230 and the curve 260 is approximately proportional to the probability of a newly measured substrate 110 having a measured substrate parameter 204 falling in that range 230. Therefore, the probability distribution curve 260 can be advantageously used to define the bin data set 212.

In another example, the bin data set 212 is generated by defining the ranges 230 of substrate parameters so that a determined substrate parameter has an approximately equal probability of being contained in any one of the ranges 230, as illustrated in FIG. 4. Therefore, if the ranges 230 are delimited so that the area 270 between the curve 260 and each range 230 is equal, the bins 214 delimit ranges 230 of substrate parameters that have an approximately equal probability of being determined.

In yet another example, the bins 214 delimit the ranges 230 of substrate parameters to provide maximum coverage of the probability distribution for a limited number of bins 214 or a limited size of the ranges 230. The ranges 230 of substrate parameters can be selected to comprise substrate parameters that have a high probability of being determined. For example, a minimal or decreased number of bins 214 can delimit ranges 230 in which the probability distribution curve 260 is high. For example, a suitably high probability is one that is above the mean of the total range of substrate parameters.

After the controller 180 determines a substrate parameter and obtains a bin data set 212, the controller then identifies the bin 214 containing the measured substrate parameter 204 by, for example, comparing the determined substrate parameter 204 to the ranges 230 of substrate parameters in each of the bins 214, in order to identify the bin 214 that contains the measured substrate parameter 204. For example, the controller 180 may search for the measured substrate parameter 204 in the ranges 230 delimited by the bins 214 until it finds a range 230 containing the measured substrate parameter 204.

In addition to defining a range 230 of substrate parameters, each bin 214 is also associated with a bin instruction 216 that is to be followed if the determined substrate parameter 204 is contained in the range 230 of the bin 214. After a particular bin 214 is identified, the controller 180 retrieves the bin's associated bin instruction 216 and generally performs the instructions by operating the apparatus components 101 in response to the associated bin instruction 216. The bin instruction 216 comprises instruction code, such as computer program code, for example in the form of binary code instructions, which may be used to perform an operation relating to the registration of an image 85 on the substrate 110. For example, the bin instruction 216 may comprise instructions to initiate another determination of the substrate parameter, for example if the previously determined substrate parameter 204 is suspected to be erroneous or otherwise problematic. For example, the measured substrate parameter 204 may be suspected to be erroneous because it does not fall within recognizable values that have been empirically determined. The measured substrate parameter 204 may also be erroneous if multiple measurements are made and they are inconsistent with one another. Thus, the controller 180 repeats the determination of the substrate parameter, and after repeating determination of the substrate parameter, the substrate may be registered, rejected, or otherwise processed.

In another example, the controller 180 rejects a substrate 110 in response to a bin instruction 216 that is a substrate reject instruction 211. For example, the substrate 110 may be rejected when measurements of a distortion level of the substrate 110 indicate that the substrate 110 is too distorted to register a good circuit image 85. A substrate reject instruction 211 may also be associated with bins 214 that delimit specific ranges 230 of substrate parameters that are determined to be anomalous or troublesome. For example, bins 214 that delimit ranges 230 having extremes of low or high image scaling factors may be associated with the substrate reject instruction 211, especially if the scaled image would be substantially distorted. In another example, the substrate reject instruction 211 is associated with a bin 214 that delimits a range 230 of substrate parameters that have a low probability of being determined, such as because they are empirically determined not to occur very often, for example, having a probability of less than the mean.

In yet another example, the controller 180 scales an image and communicates with the components to register the image on the substrate 110. In this example, one or more of the bin instructions 216 comprises an image scaling factor, such as instructions to scale the circuit image using a predefined image scaling factor 210 that is associated with the bin 214, and hence, associated with the range 230 of substrate parameters represented by the bin 214. In one version, also illustrated in FIG. 3, each bin 214 delimits a range 230 of substrate parameters comprising image scaling factors, and one or more bin instructions 216 comprises an image scaling factor 210 that is the midpoint of the range 230 of image scaling factors. For example, if the low and high limits of a range 230 of image scaling factors are I and h, respectively, the predefined image scaling factor 210 associated with the range 230 is (I+h)/2. An image scaling factor 210 of 1 represents no scaling. The circuit image is scaled according to the predefined image scaling factor 210 associated with the bin 214, and thereafter, the scaled image is registered on the substrate 110.

In a particular version, the controller 180 is adapted to scale a first image and communicate with the components 101 to register the scaled first image on a first side of the substrate 110, and thereafter, scale a second image and communicate with the components 101 to register the scaled second image on a second side of the substrate 110. The controller 180 may be adapted to communicate with the components 101 to register the first and second images simultaneously or in sequence. Additionally, the measured substrate parameter 204 may represent an image scaling factor 205 measured for each side of the substrate 110, or a fiducial mark deviation measured for each side of the substrate 110. In one example, the controller 180 identifies a bin 214 having an associated bin instruction 216 that is an image scaling factor 210, and scales the first and second images according to the identified image scaling factor 210. For example, the controller 180 may determine a plurality of substrate parameters for one or more sides of the substrate 110 and use one, both, or the average of the substrate parameters, as the measured substrate parameter 204.

For example, two sides of a circuit board can be registered sequentially with two corresponding images. And the two images may be scaled in relation to a bin 214 comprising an image scaling factor 210 that is determined from the image scaling factor 205 determined for each of the two sides of the circuit board. For example, the determined image scaling factor 210 may be the mean of the two image scaling factors 205 of the two sides of the substrate 110.

The image to be registered on the substrate 110 may be scaled by a number of different methods. For example, along the scan axis, scaling may be accomplished by changing the time scale of modulation of the radiation beam 135 being scanned across the substrate 110. If the beam 135 is modulated faster and the scan speed is conserved, the registered image is shrunk. If the beam 135 is modulated slower and the scan speed is conserved, the registered image is stretched. The support motion may have to be adjusted according to the beam modulation speed in order to maintain seamless registration of the image on the substrate 110. Along the axis of substrate support motion, scaling may be accomplished by changing the speed of motion of the support 105. The registered image is shrunk when the support motion is slowed down and stretched when the support motion is sped up. The beam modulation may have to be adjusted according to the support motion speed in order to maintain seamless registration of the image on the substrate 110.

In operation, a substrate 110 is placed on the substrate support 105 to measure a substrate parameter 204 of the substrate 110. While any substrate dimension may be used to measure the substrate parameter 204, typically the locations of the fiducial marks 177 on the substrate 110 are measured, and deviations of the measured locations of the fiducial marks 177 from their original designed locations are calculated to determine an image scaling factor 205. Typically, the apparatus 100 comprises a fiducial mark locator 175 to measure a fiducial mark deviation of one or more fiducial marks 177 on the substrate 110, and wherein the controller is adapted to communicate with the fiducial mark locator 175 and to determine a substrate parameter comprising an image scaling factor from a fiducial mark deviation. Thereafter, the controller may scale the image 85 to be registered on the substrate in accordance with the determined image scaling factor. For example, a fiducial mark locator 175 comprising a charge-coupled device (CCD) array camera may be used to measure the position of the fiducial marks 177 of the substrate 110 to determine the distortion level of the substrate 110. Also, the measured substrate parameter 204 may be determined along a single axis in a surface plane of the substrate 110, or along a plurality of axes, such as orthogonal axes. The controller 180 may also determine a plurality of substrate parameters for one or more sides of the substrate 110 and use one, both, or the average of the substrate parameters, as the determined substrate parameter.

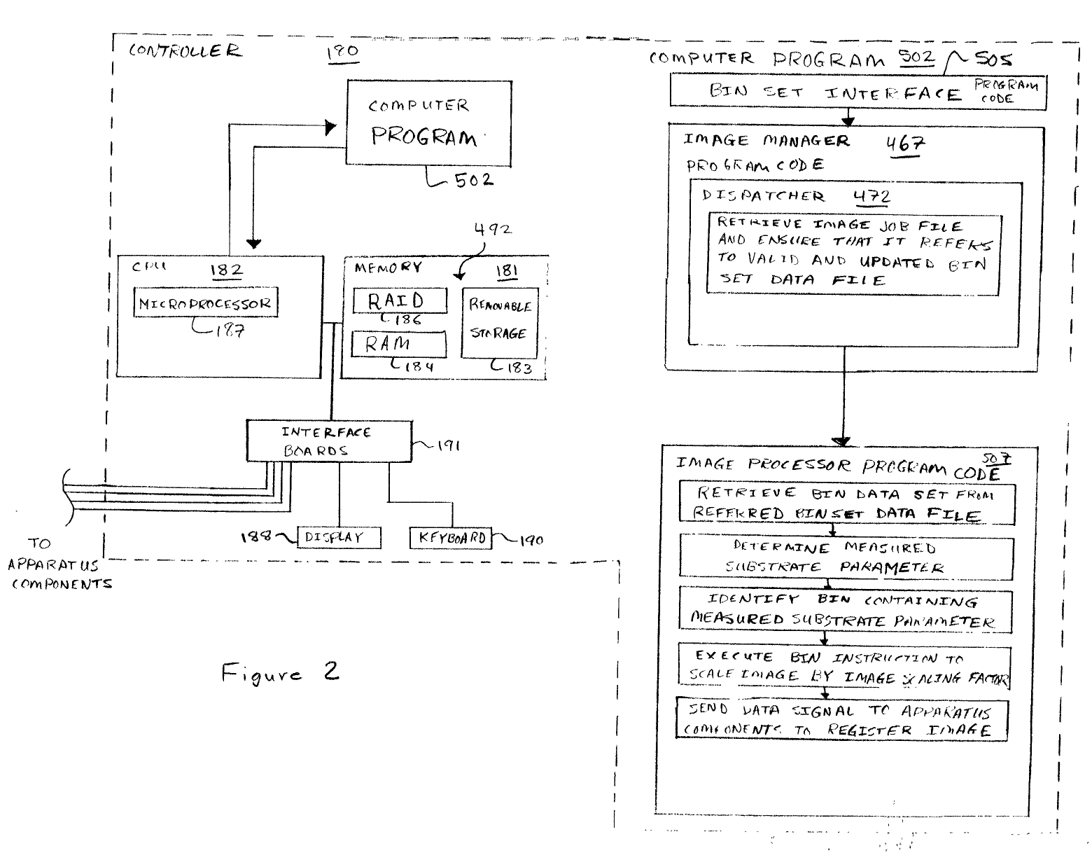

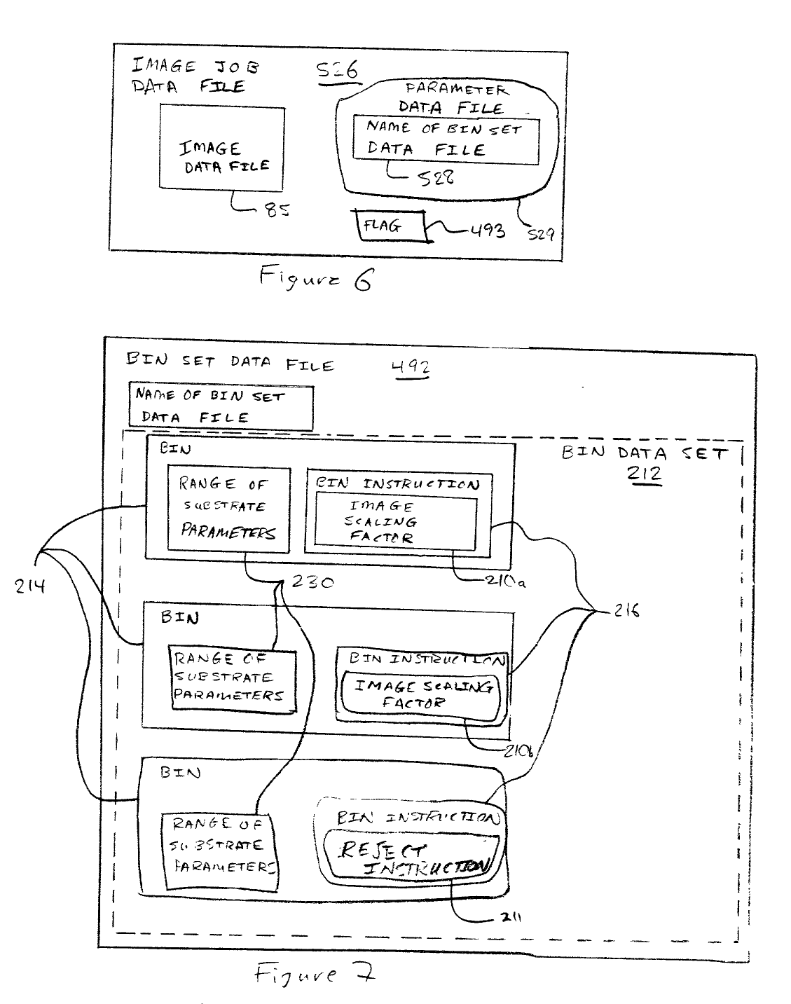

In one embodiment, as illustrated in FIGS. 2 and 6 the controller 180 operates a computer program 195 that contains Bin Set Program Code 505 to create, customize, retrieve, and store the bin data set 212 in the form of a bin set data file 492; Image Manager Program Code 467 to organize and maintain image job data files 526 and also assist in maintaining the bin set data files 492; and Image Processing Program Code 507 to perform operations on the image to register it onto the substrate 110.

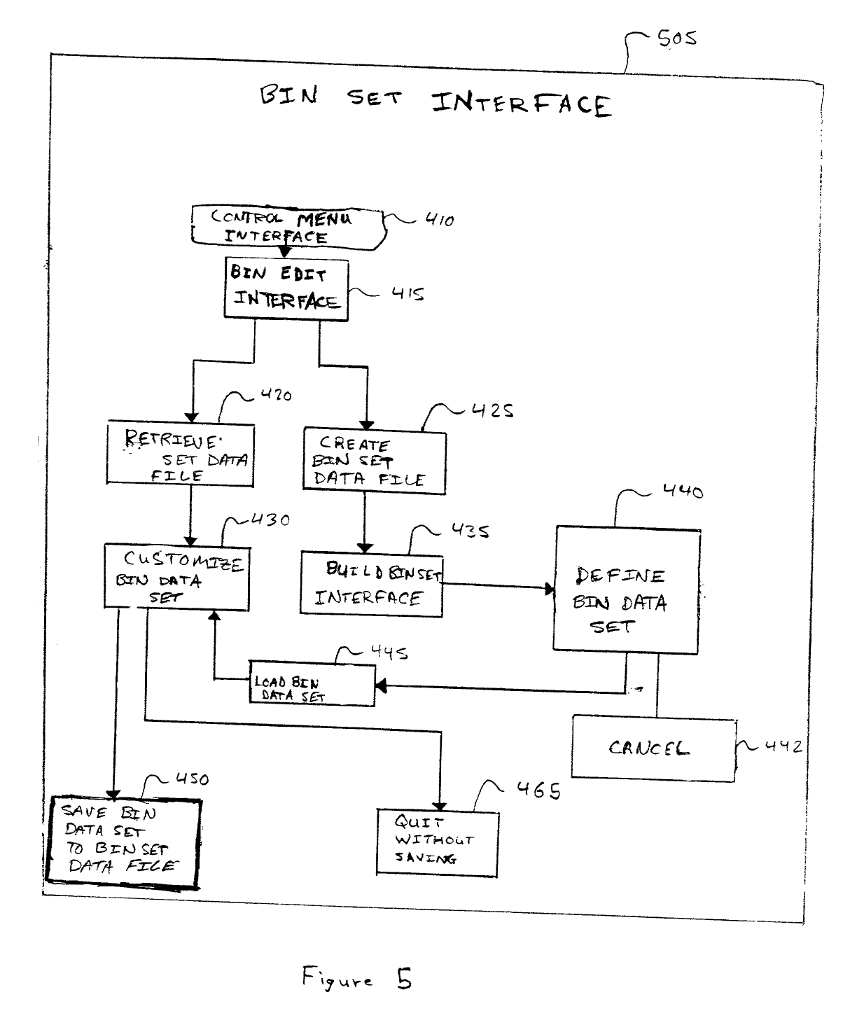

In operation, the Bin Set Program Code 505 allows an operator to create, customize, retrieve, and store the bin data set 212 in the form of a bin set data file 492, as for example illustrated in FIG. 5. The Bin Set Program Code 505 generates a Control Menu Interface 410, from which the operator can select and generate a Bin Edit Interface 415. The Bin Edit Interface 415 opens with an editing window, from which the operator can then choose whether to retrieve an existing bin set data file, as in step 420, or create a new bin set data file (step 425). Selecting step option 425 generates a Build Bin Set Interface 435 that contains the minimum image scaling factor 240 and maximum image scaling factor 250 for the substrate 110. The operator selects the number of bins 214 desired and how the associated bin instruction 216 is determined. For example, where the bin instruction comprises an image scaling factor, an operator can specify how the associated image scaling factor 210 for each bin instruction 216 is to be calculated, via one of the following settings: “None,” Half,“or “Custom,” as in step 440. “None” indicates that a continuous range 230 of image scaling factors should be used as the associated image scaling factor 210 for the bin instruction 216. “Half” indicates that the midpoint value of the range 230 delimited by the bin 214 should be used as the associated image scaling factor 210 for the bin instruction 216. “Custom” indicates that an image scaling factor selection method other than “None” and “Half” should be used to determine the image scaling factor 210 for the bin instruction 216. The average width of the image scaling factor range 230 of each bin 214 is then displayed. Afterward, the operator can either cancel the Build Bin Set Interface, as in step 442 (nothing is saved in the memory 181), or pass the bin data set into the Bin Edit Interface 415, as in step 445; both options return the operator to the Bin Edit Interface 415. Within the Bin Edit Interface 415, the operator can individually customize the bins 214 (for example, the width of the range of image scaling factors and the associated image scaling factor 210 of a bin 214), as in step 430, and indicate if the bin data set pertains to one or both substrate axes. The operator can then choose to save the bin data set to a bin set data file 492 in the memory 181, as in step 450, or quit without saving to the memory 181, as in step 465. The Bin Edit Interface 415 is expected to be used by the operator only when a new image, such as a PCB layout, and/or a new type of substrate 110, such as a differently sized substrate 110, is first brought into production. The new bin data set 212 is expected to remain constant during a particular manufacturing cycle. However, the operator always retains the option of customizing the bins 214 for any image job data file 526 prior to the registration of the image on the substrate 110.

The Image Manager Program Code 467 organizes and maintains image job data files 526 and bin set data files 492. An image job data file 526 is a data file comprising the image data file that is received by the Image Manager Program Code 467 and passed to the Image Processing Program Code 507. The Image Manager Program Code 467 comprises Dispatcher Program Code 472, which reads a parameter file 529 of the image job data file 526, such as a job description file (JDF) (step 475), and ensures that the correct bin set data files 492 are properly located in the memory 181 of the controller 180 (step 480). The Dispatcher Program Code 472 ensures this by retrieving a file name 528 of a bin set data file from the parameter file 529, and checking whether the named bin set data file 492 exists and is updated in the memory 181. To check whether the named bin set data file 492 is updated, the Dispatcher Program Code 472 may compare, for example, a bin set data file 492 having the file name 528 and retrieved from a volatile section of the memory 181 to a bin set data file 492 having the same file name 528 and in a backup section of the memory 181; if any differences are detected, the Dispatcher Program Code 472 updates the out-of-date bin set data file 492 in the volatile section by copying the newer bin set data file 492 from the backup section. The Dispatcher Program Code 472 then sets a flag 493 in the image job data file 526, which is passed to the controller 180 to inform it that the new bin data set 212 must be retrieved before transferring the image job data file 526 to the Image Processing Program Code 507. The Dispatcher Program Code 472 also comprises program code to submit an image job data file 526 to the Image Processor 507 after ensuring 480 that the proper bin set data files 492 are stored in the memory 181 of the controller 180 prior to submitting the image job data file 526.

The Image Processing Program Code 507 receives the image job data file 526 from the Dispatcher Program Code 472 and performs imaging operations, such as determining a measured substrate parameter 204 of the substrate 110, identifying a bin containing the substrate parameter, executing a bin instruction 215 to scale an image according to the bin's associated image scaling factor 210, and sending a data signal to the apparatus components 101 to register the scaled image on the substrate 110. The parameter file of the image job data file 526 contains parameters that are used to modify the functionality of the Image Processing Program Code 507 or affect other aspects of a set of image registration steps.

Although the present invention has been described in considerable detail with regard to certain preferred versions thereof, other versions would be apparent to those of ordinary skill in the art. For example, the present invention could be used with other types of image registration apparatuses that register images using other methods or for other purposes. Thus, the appended claims should not be limited to the description of the preferred versions contained herein.

What is claimed is:

1. An image registration apparatus comprising:
(a) components adapted to generate, modulate and scan one or more radiation beams across the substrate, the components including a substrate support capable of supporting a substrate; and
(b) a controller adapted to (i) determine a substrate parameter, (ii) obtain a bin data set that defines a plurality of bins that each delimit a range of the substrate parameters and have an associated bin instruction, (iii) identify the bin containing the determined substrate parameter and the associated bin instruction, and (iv) repeat the determination of the substrate parameter, reject the substrate, or scale an image and communicate with the components to register the image on the substrate.

2. An apparatus according to claim 1 wherein the substrate parameter comprises an image scaling factor to scale the image to be registered on the substrate.

3. An apparatus according to claim 2 further comprising a fiducial mark locator to measure a fiducial mark deviation of one or more fiducial marks on the substrate, and wherein the controller is adapted to communicate with the fiducial mark locator and to determine a substrate parameter comprising an image scaling factor from a fiducial mark deviation.

4. An apparatus according to claim 3 wherein the controller scales the image to be registered on the substrate in accordance with the determined image scaling factor.

5. An apparatus according to claim 1 wherein one or more of the bin instructions comprises an image scaling factor.

6. An apparatus according to claim 5 wherein each bin delimits a range of substrate parameters comprising image scaling factors, and one or more bin instructions comprise an image scaling factor that is the midpoint of the range of image scaling factors.

7. An apparatus according to claim 1 wherein one or more of the bin instructions comprises a substrate reject instruction.

8. An apparatus according to claim 7 wherein the substrate reject instruction is associated with a bin that delimits a range of substrate parameters that have a low probability of being determined.

9. An apparatus according to claim 1 wherein the ranges of substrate parameters are delimited so that a determined substrate parameter has an approximately equal probability of being contained in any one of the ranges.

10. An apparatus according to claim 1 wherein the ranges of substrate parameters are approximately equally sized.

11. An apparatus according to claim 1 wherein the ranges of substrate parameters are selected to comprise substrate parameters that have a high probability of being determined.

12. An apparatus according to claim 1 wherein the controller is adapted to scale a first image and communicate with the components to register the scaled first image on a first side of the substrate, and scale a second image and communicate with the components to register the scaled second image on a second side of the substrate.

13. An apparatus according to claim 12 wherein the controller is adapted to communicate with the components to register the first and second images simultaneously or in sequence.

14. An apparatus according to claim 12 wherein the controller identifies a bin having an associated bin instruction that is an image scaling factor, and scales the first and second images according to the identified image scaling factor.

15. An apparatus according to claim 12 wherein the controller determines a plurality of substrate parameters for one or more sides of the substrate and uses one, both, or the average of the substrate parameters, as the determined substrate parameter.

16. An apparatus according to claim 1 wherein the controller is adapted to generate the bin data set by allowing an operator to define the bins.

17. An apparatus according to claim 1 wherein the controller is adapted to generate the bin data set by operating the components to measure substrate parameters for a plurality of test substrates, evaluate a probability distribution of the measured substrate parameters, and define the bin data set according to the probability distribution.

18. An apparatus according to claim 1 wherein the controller comprises bin set software capable of creating, editing, maintaining, retrieving, or storing the bin data set.

19. An image registration method comprising:
(a) placing a substrate on a substrate support;
(b) determining a substrate parameter for the substrate;
(c) obtaining a bin data set defining a plurality of bins that each delimit a range of substrate parameters and have an associated bin instruction;
(d) identifying the bin containing the determined substrate parameter and the associated bin instruction; and
(e) in response to the bin instruction, repeating the determination of the substrate parameter, rejecting the substrate, or scaling and registering an image on the substrate.

20. A method according to claim 19 wherein the substrate parameter comprises an image scaling factor to scale the image to be registered on the substrate.

21. A method according to claim 20 further comprising determining a substrate parameter comprising an image scaling factor from a measured fiducial mark deviation of one or more fiducial marks on the substrate.

22. A method according to claim 21 comprising scaling the image to be registered on the substrate in accordance with the determined image scaling factor.

23. A method according to claim 19 wherein one or more of the bin instructions comprises an image scaling factor.

24. A method according to claim 23 wherein each bin delimits a range of substrate parameters comprising image scaling factors, and one or more bin instructions comprise an image scaling factor that is the midpoint of the range of image scaling factors.

25. A method according to claim 19 wherein one or more of the bin instructions comprises a substrate reject instruction.

26. A method according to claim 25 wherein the substrate reject instruction is associated with a bin that delimits a range of substrate parameters that have a low probability of being determined.

27. A method according to claim 19 wherein the ranges of substrate parameters are delimited so that a determined substrate parameter has an approximately equal probability of being contained in any one of the ranges.

28. A method according to claim 19 wherein the ranges of substrate parameters are approximately equally sized.

29. A method according to claim 19 wherein the ranges of substrate parameters are selected to comprise substrate parameters that have a high probability of being determined.

30. A method according to claim 19 comprising scaling a first image and communicating with the components to register the scaled first image on a first side of the substrate, and scaling a second image and communicating with the components to register the scaled second image on a second side of the substrate.

31. A method according to claim 30 comprising communicating with the components to register the first and second images simultaneously or in sequence.

32. A method according to claim 30 comprising identifying a bin having an associated bin instruction that is an image scaling factor, and scaling the first and second images according to the identified image scaling factor.

33. A method according to claim 30 comprising determining a plurality of substrate parameters for one or more sides of the substrate and using one, both, or the average of the substrate parameters, as the determined substrate parameter.

34. A method according to claim 19 comprising generating the bin data set by allowing an operator to define the bins.

35. A method according to claim 19 comprising generating the bin data set by operating the components to measure substrate parameters for a plurality of test substrates, evaluate a probability distribution of the measured substrate parameters, and define the bin data set according to the probability distribution.

36. A method according to claim 19 wherein the controller executes bin set software to create, edit, maintain, retrieve, or store the bin data set.
